(19) United States
(12) Patent Application Publication
(10) Pub. No.: US 2012/0303874 A1
(43) Pub. Date: Nov. 29, 2012

(54) INFORMATION PROCESSING UNIT AND INFORMATION PROCESSING METHOD

(75) Inventor: Yohei Yamaguchi, Tokyo (JP)

(73) Assignee: SONY CORPORATION, Tokyo (JP)

(21) Appl. No.: 13/463,908

(22) Filed: May 4, 2012

(30) Foreign Application Priority Data
May 24, 2011 (JP) 2011-116242

(51) Int. Cl. G06F 12/00

(52) U.S. Cl. 711/103; 711/E12.008

(57) ABSTRACT

There are provided an information processing unit and an information processing method which are capable of reducing a startup time. The information processing unit includes: a volatile memory temporarily holding, as memory data, information which indicates a plurality of programs; a nonvolatile memory; and a page information generation section generating page information which identifies memory data for a plurality of predetermined pages from memory data stored in the volatile memory. The page information includes a memory address for each page in the volatile memory, and a program number of a program including memory data for each page.

### CROSS-REFERENCE TO RELATED APPLICATION

The present application claims priority from Japanese Patent Application No. JP 2011-116242 filed in the Japanese Patent Office on May 24, 2011, the entire content of which is incorporated herein by reference.

### BACKGROUND

This disclosure relates to an information processing unit and an information processing method which restore data in a volatile memory to a predetermined state after power-on.

In recent years, with development of technology, various electronic units (information processing units) such as mobile music players and television receivers have become multifunctional. For example, similarly to a personal computer, such an information processing unit includes a central processing unit (CPU) and a main memory device (memory), and executes various programs, thereby achieving various functions.

Such an information processing unit needs to execute various programs for startup of devices after power-on, and thus startup may take a longer time. Therefore, various studies have been made to reduce the startup time. For example, in Japanese Unexamined Patent Application Publication No. 2009-187134, an information processing unit is disclosed in which, during transition to a paused state, a snapshot of a memory is generated by a process unit and is stored in a nonvolatile memory, and during recovery from the paused state, the snapshot is preferentially restored to a main memory device from the snapshot of the process necessary for the start of an own device.

### SUMMARY

Such an information processing unit desirably takes a shorter time for startup, and speed-up of the startup of the unit is expected.

It is desirable to provide an information processing unit and an information processing method which are capable of reducing a startup time.

According to an embodiment of the disclosure, there is provided a first information processing unit including: a volatile memory temporarily holding, as memory data, information which indicates a plurality of programs; a nonvolatile memory; and a page information generation section generating page information which identifies memory data for a plurality of predetermined pages from memory data stored in the volatile memory. The page information includes a memory address for each page in the volatile memory, and a program number of a program including memory data for each page.

According to an embodiment of the disclosure, there is provided a second information processing unit including: a volatile memory; a nonvolatile memory holding page restoration information; and a restoration section restoring memory data for a plurality of predetermined pages to the volatile memory, based on the page restoration information.

According to an embodiment of the disclosure, there is provided a first information processing method including: executing a plurality of programs based on memory data in a volatile memory; and generating page information which includes a memory address for each of a plurality of predetermined pages in the volatile memory and a program number of a program including memory data for each of the predetermined pages, the page information identifying memory data of the predetermined pages in the memory data stored in the volatile memory.

According to an embodiment of the disclosure, there is provided a second information processing method of restoring memory data for a plurality of predetermined pages to a volatile memory, based on page restoration information stored in a nonvolatile memory.

In the first information processing unit and the first information processing method according to the embodiments of the disclosure, the page information including the memory address and the program number is generated. Then, the page information identifies memory data for the predetermined number of pages from the memory data stored in the volatile memory.

In the second information processing unit and the second information processing method according to the embodiments of the disclosure, memory data is restored to the volatile memory based on the page restoration information stored in the nonvolatile memory. At this time, memory data for the predetermined number of pages is restored to the volatile memory.

According to the first and second information processing units and the first and second information processing methods of the embodiments of the disclosure, the memory data for the predetermined number of pages is identified with use of the page information, and the memory data is restored to the volatile memory based on the page restoration information. Therefore, a startup time is allowed to be reduced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a display according to a first embodiment of the present disclosure.

FIG. 2 is a table illustrating a configuration example of an image list according to the first embodiment.

FIG. 3 is an explanatory diagram illustrating an operation example of the display illustrated in FIG. 1.

FIG. 4 is a flowchart illustrating the operation example of the display illustrated in FIG. 1.

FIG. 5 is a flowchart illustrating another operation example of the display illustrated in FIG. 1.

FIG. 6 is a block diagram illustrating a configuration example of a display according to a second embodiment of the present disclosure.

FIG. 7 is a table illustrating a configuration example of an image list according to the second embodiment.

FIG. 8 is an explanatory diagram illustrating an operation example of the display illustrated in FIG. 6.

FIG. 9 is a flowchart illustrating the operation example of the display illustrated in FIG. 6.

FIG. 10 is an explanatory diagram illustrating another operation example of the display illustrated in FIG. 6.

FIG. 11 is a flowchart illustrating another operation example of the display illustrated in FIG. 6.

FIG. 12 is a block diagram illustrating a configuration example of a display according to a third embodiment of the present disclosure.

FIG. 13 is an explanatory diagram illustrating an operation example of the display illustrated in FIG. 12.

FIG. 14 is a flowchart illustrating the operation example of the display illustrated in FIG. 12.

FIG. 15 is a flowchart illustrating another operation example of the display illustrated in FIG. 12.

### DETAILED DESCRIPTION

Hereinafter, preferred embodiments of the disclosure will be described in detail with reference to drawings. Note that the description will be given in the following order.
1. First Embodiment
2. Second Embodiment
3. Third Embodiment

### 1. First Embodiment

### [Configuration Example]

### (General Configuration Example)

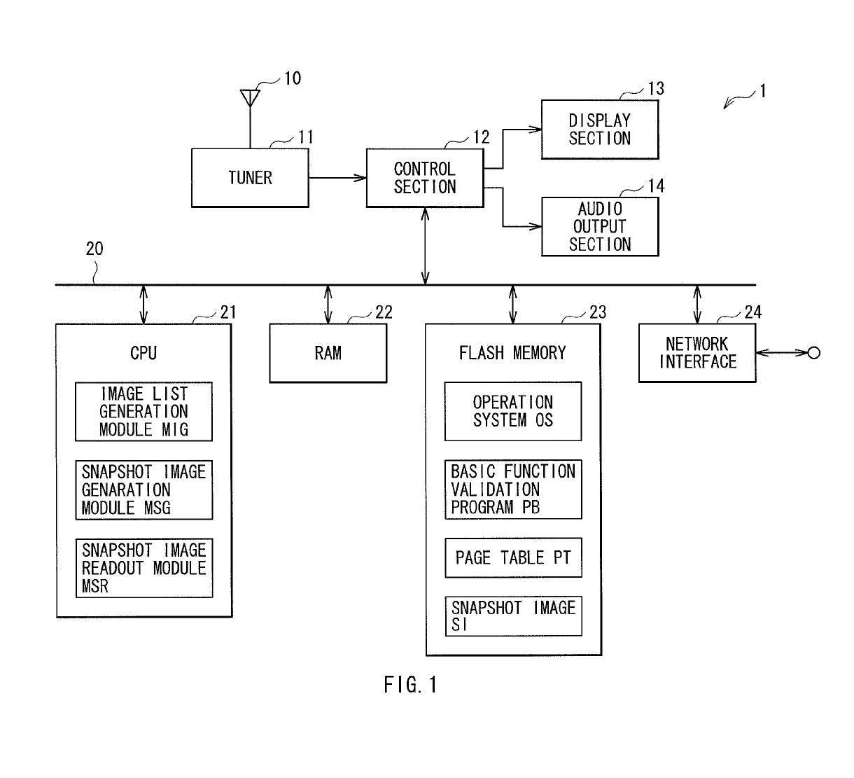

FIG. 1 illustrates a configuration example of a display according to a first embodiment. Note that an information processing unit and an information processing method according to an embodiment of the present disclosure are implemented by the embodiment, and thus are described together.

A display 1 is, for example, a television receiver which displays received broadcasting data. The display 1 includes a tuner 11, a control section 12, a display section 13, an audio output section 14, a flash memory 23, a random access memory (RAM) 22, a CPU 21, and a network interface 24. The control section 12, the CPU 21, the RAM 22, the flash memory 23, and the network interface 24 are connected through an internal bus 20, and are allowed to exchange information with one another.

The tuner 11 extracts broadcasting data related to a desired channel from broadcasting data received through an antenna 10. The control section 12 controls display of the display section 13 as well as an audio output of the audio output section 14, based on the broadcasting data supplied from the tuner 11. In addition, in this example, the control section 12 has a function to exchange information between the CPU 21, the RAM 22, the flash memory 23, and the network interface 24. The display section 13 is, for example, a liquid crystal display section which performs display on a display screen in response to a control signal supplied from the control section 12. The audio output section 14 is, for example, a speaker which outputs audio in response to a control signal supplied from the control section 12.

The flash memory 23 is a nonvolatile memory. In the flash memory 23, various programs and data including an operating system OS, a basic function validation program PB, a page table PT, a snapshot image SI, a boot loader (not illustrated), and the like are stored.

The operating system OS is so-called basic software which manages the entire display 1.

The basic function validation program PB is a program that initializes the display 1 and validates basic functions so that the display 1 performs basic functions such as decoding of received broadcasting data.

The page table PT is a table in which a relationship between a logical memory address LA and a physical memory address PA in a memory system of the display 1 is described. The logical memory address LA is a memory address viewed from the program, and the physical memory address PA is an actual memory address in the RAM 22. In the display 1, when executing each program, the CPU 21 uses the page table PT to convert the logical memory address LA into the physical memory address PA, thereby accessing the RAM 22.

As will be described later, the snapshot image SI is obtained by storing, out of memory data in the RAM 22, memory data for each page, which is expected to be necessary after power-on of the display 1. The page herein means a minimum unit of the memory data when the physical memory (the RAM 22) is managed, and a size of the page is, for example, 4 k bytes. Moreover, the snapshot image SI also includes information of the physical memory address PA corresponding to respective pages. In the display 1, after power-on, memory data in the RAM 22 is restored based on the snapshot image SI, and then programs are executed with use of the restored memory data. Accordingly, the startup time of the display 1 is allowed to be reduced.

The RAM 22 is a main memory device. For example, when the CPU 21 executes any program, the program is read out to the RAM 22, and then the CPU 21 executes the program based on the memory data in the RAM 22. In addition, temporary data generated when the CPU 21 executes any program is also stored in the RAM 22. For example, dynamic random access memory (DRAM) may be used as the RAM 22.

The CPU 21 executes programs to perform various processes. Specifically, as will be described later, for example, the CPU 21 starts the operating system OS, and then executes the basic function validation program PB, thereby validating the basic function of the display 1.

As illustrated in FIG. 1, the CPU 21 also has a function to execute an image list generation module MIG, a snapshot image generation module MSG, and a snapshot image readout module MSR.

The image list generation module MIG is executed to generate an image list IL. The image list IL is used for generating a snapshot image SI by the snapshot image generation module MSG, as will be described later.

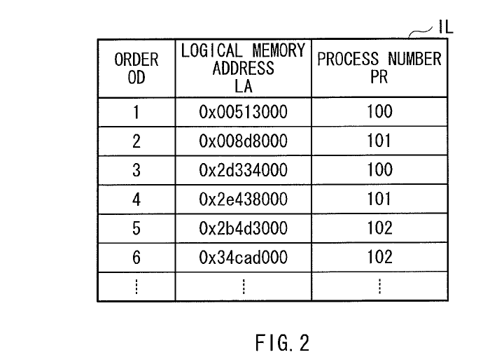

FIG. 2 illustrates a configuration example of the image list IL. The image list IL indicates various kinds of information related to the memory data in the RAM 22, which is expected to be necessary after power-on, for each page. Specifically, the image list IL includes information including a readout order OD of memory data of the relevant page read from the flash memory 23 to the RAM 22 after power-on, a logical memory address LA corresponding to the physical memory address PA of the RAM 22 in which the memory data of the page is stored, and a process number PR related to the memory data of the page.

Specifically, the memory data in the RAM 22, which is expected to be necessary after power-on, is data of the operating system OS, data (basic data BD described later) generated at the time of executing the basic function validation program PB, and the like. The image list generation module MIG identifies the memory data in the RAM 22, which is expected to be necessary after power-on, based on information described in the program itself, for example.

The snapshot image generation module MSG generates snapshot image SI and stores the snapshot image SI in the flash memory 23, based on the image list IL generated by the image list generation module MIG.

The image list generation module MIG and the snapshot image generation module MSG are executed when the various kinds of programs used in the display 1 are updated, for example. Then, the snapshot image SI generated by the snapshot image generation module MSG is stored together with the page table PT in the flash memory 23.

The snapshot image readout module MSR restores, after power-on, the memory data in the RAM 22, based on the snapshot image SI stored in the flash memory 23.

Note that, although not illustrated, the image list generation module MIG, the snapshot image generation module MSG, the snapshot image readout module MSR are stored in the flash memory 23, and are read out from the flash memory 23 to the RAM 22 when the CPU 21 executes these modules.

The network interface 24 is an interface used in connection to the Internet, for example. In this example, the display 1 acquires an updated program through the Internet, and performs update of various kinds of programs stored in the flash memory 23. Note that a method of acquiring a program is not limited to this method, and alternatively, for example, a broadcast station may superimpose an updated program on broadcast waves, and the tuner 11 may receive the program.

The RAM 22 corresponds to a specific example of “volatile memory” of the disclosure. The flash memory 23 corresponds to a specific example of “nonvolatile memory” of the disclosure. The image list IL corresponds to a specific example of “page information” of the disclosure. The process number PR corresponds to a specific example of “program number” of the disclosure. The image list generation module MIG corresponds to a specific example of “page information generation section” of the disclosure. The snapshot image SI corresponds to a specific example of “page data set” of the disclosure. The snapshot image generation module MSG corresponds to a specific example of “memory control section” of the disclosure. The snapshot image readout module MSR corresponds to a specific example of “restoring section” of the disclosure.

### [Operation and Function]

Subsequently, operation and function of the display 1 according to the first embodiment will be described.

### (General Operation Outline)

First, general operation outline of the display 1 will be described with reference to FIG. 1.

The tuner 11 extracts broadcasting data related to a desired channel from the broadcasting data received through the antenna 10. The control section 12 controls display on the display section 13 and controls audio output of the audio output section 14, based on the broadcasting data supplied from the tuner 11. The display section 13 performs display on a display screen, based on a control signal supplied from the control section 12. The audio output section 14 outputs audio, based on a control signal supplied from the control section 12.

The flash memory 23 holds various programs and data including the operating system OS, the basic function validation program PB, the page table PT, the snapshot image SI, and the like. The CPU 21 executes the programs with use of the RAM 22 as a temporal memory to perform various processes.

To start in a short time after power-on, the display restores the memory data in the RAM 22 with use of the snapshot image SI. Specifically, in the case where the program is updated, for example, the display 1 generates the snapshot image SI and stores the snapshot image SI in the flash memory 23. Then, in a subsequent power-on state, the display 1 starts with use of the snapshot image SI. Hereinafter, generation of the snapshot image SI and startup of the display 1 with use of the snapshot image SI will be described.

### (Generation of Snapshot Image SI)

In the display 1, first, the CPU 21 executes the image list generation module MIG to generate an image list IL, based on the memory data in the RAM 22, which is expected to be necessary after power-on. Then, the CPU 21 executes the snapshot image generation module MSG to generate the snapshot image SI, based on the image list IL. The detail thereof will be described below.

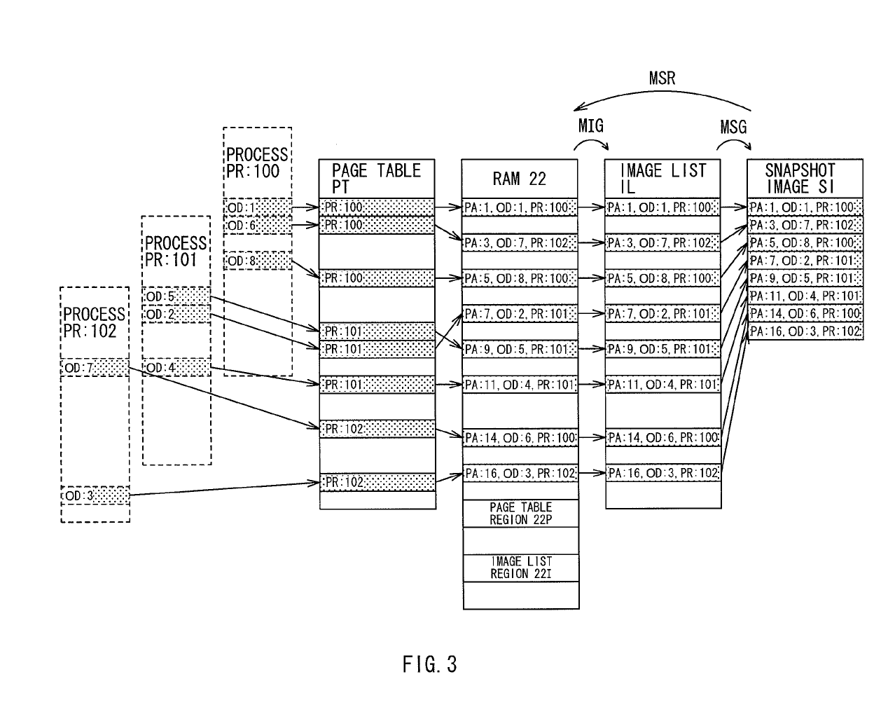

FIG. 3 schematically illustrates memory spaces in the display 1. When executing each process (program) of the process number PR: 100, 101, and 102, the CPU 21 uses the page table PT stored in a page table region 22P of the RAM 22 to convert the logical memory address LA into the physical memory address PA, thereby accessing the RAM 22.

When generating the image list IL, the CPU 21 executes the image list generation module MIG. As will be described later, in the image list generation module MIG, pieces of information related to the memory data in the RAM 22, which is expected to be necessary after power-on, are collected for each page, and the image list IL illustrated in FIG. 2 is generated.

Then, when generating the snapshot image SI, the CPU 21 executes the snapshot image generation module MSG. In the snapshot image generation module MSG, corresponding pieces of memory data are collected from the RAM 22 to generate the snapshot image SI, based on the image list IL generated by the image list generation module MIG.

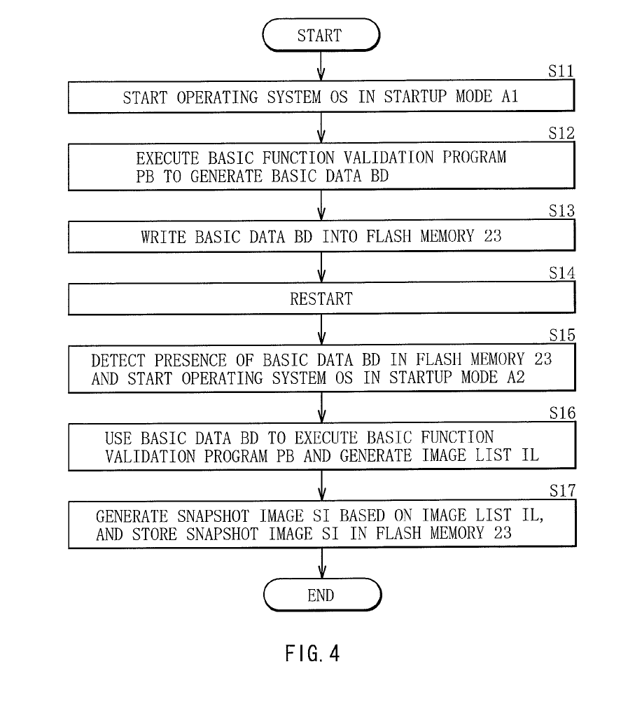

FIG. 4 illustrates a flowchart of the generation of the snapshot image SI. In the display 1, the CPU 21 executes the basic function validation program PB, and after the basic function is validated, the image list generation module MIG generates the image list IL and the snapshot image generation module MSG generates the snapshot image SI. The detail thereof will be described below.

First, the CPU 21 executes a boot loader to detect that a current mode is a mode for generating the snapshot image SI, and starts the operating system OS in a startup mode A1 (step S11). In the startup mode A1, the CPU 21 reads out the data of the operating system OS from the flash memory 23 to the RAM 22, and then starts the operating system OS.

Subsequently, the CPU 21 executes the basic function validation program PB (step S12). As a result, in the display 1, the basic function is validated. At this time, the basic function validation program PB generates basic data BD including a state of the display 1 and the like, and stores the basic data BD in a writable region of the RAM 22.

Next, the CPU 21 writes the basic data BD generated in the step S12 into the flash memory 23 (step S13), and then restarts the display 1 (step S14).

Then, the CPU 21 executes a boot loader to detect presence of the basic data BD in the flash memory 23, and starts the operating system OS in a startup mode A2 (step S15). In the startup mode A2, similarly to the startup mode A1, the CPU 21 reads out the data of the operating system OS from the flash memory 23 to the RAM 22, and then starts the operating system OS.

After that, the CPU 21 executes the basic function validation program PB and executes the image list generation module MIG to generate the image list IL, with use of the basic data BD (step S16). Specifically, the CPU 21 uses the basic data BD generated in the step S12 to execute the basic function validation program PB, thereby validating the basic function in a time shorter than the time taken by the steps S11 and S12. Then, in the step S16 (execution of the basic function validation program PB), the image list generation module MIG acquires the readout order OD of the page related to the memory data in the RAM 22, which is expected to be necessary after power-on, from the flash memory 23, the logical memory address LA of the page, and the process number PR related to the page. Thereafter, the image list generation module MIG generates the image list IL based on the information, and stores the image list IL in the RAM 22.

Subsequently, the CPU 21 executes the snapshot image generation module MSG to generate the snapshot image SI based on the image list IL, thereby storing the snapshot image SI in the flash memory 23 (step S17). Specifically, the snapshot image generation module MSG first acquires a physical memory address PA, in the RAM 22, of each page described in the image list IL, based on the logical memory address LA and the process number PR which are described in the image list IL, and the page table PT. Next, the snapshot image generation module MSG acquires the memory data of the acquired physical memory address PA from the RAM 22. Subsequently, the snapshot image generation module MSG acquires the memory data for all pages described in the image list IL in this way, and generates the snapshot image SI based on the acquired memory data and information of the physical memory address PA of each page. Then, the snapshot image generation module MSG stores the generated snapshot image SI in the flash memory 23.

The flow is completed in this way. As described above, in the display 1, the snapshot image SI is generated. In the subsequent power-on state, the display 1 restores the memory data of the RAM 22 based on the snapshot image SI, and starts the system.

(Startup of Display 1 with Use of Snapshot Image SI)

When the memory data of the RAM 22 is restored, the CPU 21 executes the snapshot image readout module MSR, as illustrated in FIG. 3. As will be described later, the snapshot image readout module MSR restores the memory data of the RAM 22, based on the snapshot image SI stored in the flash memory 23.

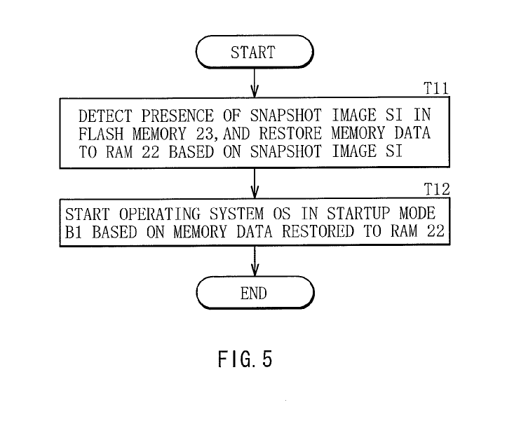

FIG. 5 illustrates a flowchart of startup of the display 1 with use of the snapshot image SI. In the display 1, in the power-on state, after the CPU 21 executes the snapshot image readout module MSR to restore the memory data of the RAM 22, the CPU 21 starts the operating system OS based on the restored memory data. The detail thereof will be described below.

First, the CPU 21 executes the boot loader to detect presence of the snapshot image SI in the flash memory 23, and executes the snapshot image readout module MSR, thereby restoring the memory data of the RAM 22 based on the snapshot image SI (step T11). Specifically, the snapshot image readout module MSR reads out respective pieces of memory data from the flash memory 23 to the RAM 22 based on the memory data for each page and the information of the physical memory address PA corresponding to the memory data, thereby restoring the memory data of the RAM 22.

Next, the CPU 21 starts the operating system OS in a startup mode B1, based on the memory data restored to the RAM (step T12). Specifically, the CPU 21 jumps to a start memory address in the RAM 22 in which the memory data has been restored, and performs startup of the operating system OS from the address. In the startup mode B1, the CPU 21 starts the operating system OS based on the minimum memory data which is restored to the RAM 22 in a unit of page. Then, the CPU 21 executes the basic function validation program PB based on the restored memory data.

The flow is completed in this way.

As described above, since the display 1 uses the snapshot image SI to perform startup after power-on, the startup time is allowed to be reduced. In other words, for example, in the startup modes A1 and A2, the CPU 21 reads out the data of the operating system OS from the flash memory 23 to the RAM 22, and then starts the operating system OS. Subsequently, while reading out the data of the basic function validation program PB, the CPU 21 executes the program to validate the basic function. As a result, for example, when the page fault occurs, the execution of the program by the CPU is temporarily stopped, and thus there is a possibility that the startup takes longer time. On the other hand, in the startup mode B1 after power-on, since minimum memory data is restored to the RAM 22 and then the display 1 is started. Accordingly, the possibility of occurrence of the page fault is reduced, and thus the startup time is allowed to be reduced.

Moreover, in the display 1, the image list generation module MIG and the snapshot image generation module MSG acquire the memory data of the RAM 22, which is expected to be necessary after power-on, for each page to generate the snapshot image SI. Specifically, for example, compared with the case where the memory data is acquired for each process, the data amount of the snapshot image SI is allowed to be reduced. Accordingly, in the display 1, the data amount is reduced when the memory data is restored to the RAM 22 after power-on, and thus the startup time is allowed to be reduced.

Typically, a program uses a plurality of program components such as a driver and a middleware as a library. If a snapshot image SI is generated by acquiring memory data of the RAM 22, which is expected to be necessary after power-on, not for each page but for each process (program), it is conceivable that the process (program) is configured by incorporating and combining the plurality of program components, and thus the startup time is allowed to be reduced. However, when the program is configured by incorporating and combining the plurality of program components in this way, development of the program becomes difficult due to complicated verification and the like, and may take significant time.

In contrast, in the display 1, the memory data of the RAM 22, which is expected to be necessary after power-on, is acquired for each page to generate the snapshot image SI. Accordingly, development of the program is individually performed for each program component, and therefore the verification is also performed individually. In other words, in this case, development of the program is allowed to be efficiently performed.

### [Effect]

As described above, in the embodiment, to generate the snapshot image SI, the memory data of the RAM 22, which is expected to be necessary after power-on, is acquired for each page. Therefore, the amount of the data read out when the memory data of the RAM 22 is restored after power-on is allowed to be reduced and the startup time is reduced accordingly. In addition, development of the program is allowed to be efficiently performed, compared with the case where the memory data of the RAM 22, which is expected to be necessary after power-on, is acquired for each process.

Moreover, in the embodiment, after power-on, the memory data of the RAM 22 is restored based on the snapshot image SI and then the system is started. Therefore, possibility of occurrence of the page fault is allowed to be reduced and the startup time is reduced accordingly.

Furthermore, in the embodiment, the image list is generated and the snapshot image is generated based on the image list. Therefore, the image list matching for purpose of the operation is generated and startup optimized for the purpose of the operation is allowed to be performed. Specifically, for example, in the case where the present technology is applied to a mobile information terminal in place of a display, when an image list for browsing the Internet is used, a startup time of the internet browser after startup of the terminal is allowed to be reduced. When an image list for a music player is used, a startup time of a music program after startup of the terminal is allowed to be reduced.

### 2. Second Embodiment

A display 2 according to a second embodiment is now described. In the second embodiment, restoration of memory data in the RAM 22 and execution of a program are performed concurrently after power-on. Note that like numerals are used to designate substantially like components of the display 1 according to the above-described first embodiment, and the description thereof is appropriately omitted.

### [Configuration]

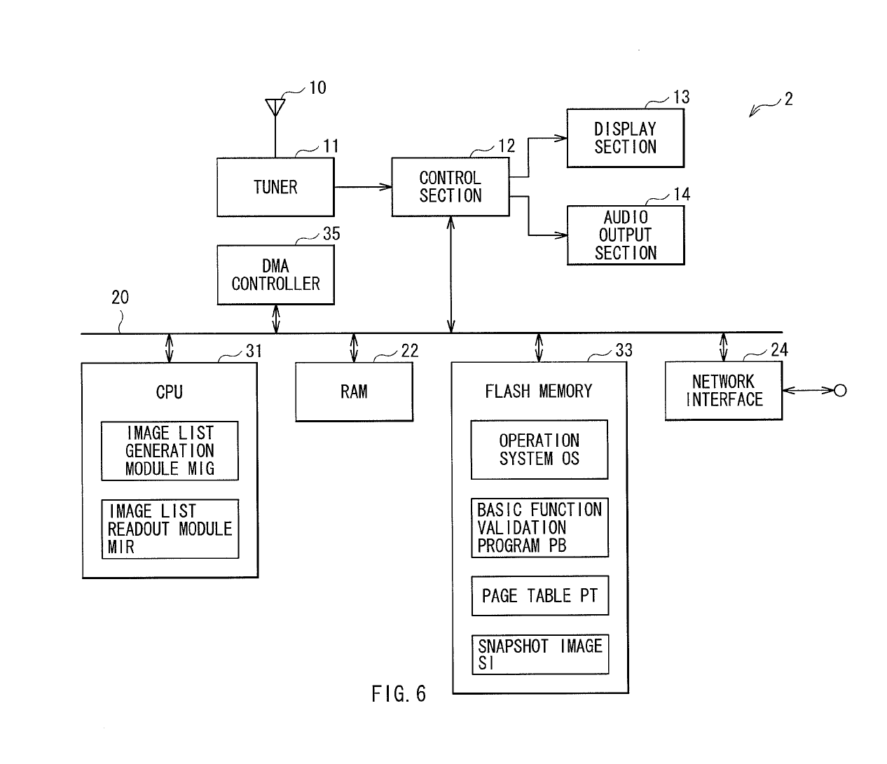

FIG. 6 illustrates a configuration example of the display 2 according to the second embodiment. The display 2 includes a flash memory 33, a CPU 31, and a direct memory access (DMA) controller 35.

An image list IL2 is stored in the flash memory 33. As will be described later, after power-on, the display 2 restores memory data in the RAM 22 based on the image list IL2. In other words, although the display 1 according to the above-described first embodiment restores the memory data in the RAM 22 based on the snapshot image SI after power-on, the display 2 according to the second embodiment restores memory data in the RAM 22 based on the image list IL2.

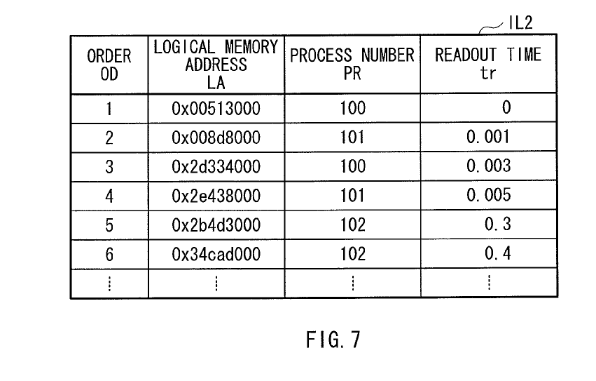

FIG. 7 illustrates a configuration example of the image list IL2. As illustrated in FIG. 7, the image list IL2 includes information of timings (read-out time tr) at which memory data of a corresponding page is read out from the flash memory 33 to the RAM 22 as will be described later, in addition to information of the image list IL according to the above-described first embodiment (FIG. 2).

As illustrated in FIG. 6, the CPU 31 has a function to execute an image list generation module MIG2 and an image list readout module MIR.

The image list generation module MIG2 generates the image list IL2, and stores the image list IL2 in the flash memory 33. The image list readout module MIR restores memory data of the RAM 22, based on the image list IL2 stored in the flash memory 33 and the data of a program (file FL) stored in the flash memory 33 after power-on.

Note that although not illustrated, the image list generation module MIG2 and the image list readout module MIR are stored in the flash memory 33, and are read out from the flash memory 33 to the RAM 22 when the CPU 31 executes these modules.

The DMA controller 35 controls data exchange between the RAM 22 and the flash memory 33 in this example. In the display 2, by using the DMA controller 35, data exchange between the RAM 22 and the flash memory 33 is allowed to be performed not through the CPU 31.

Herein, the image list IL2 corresponds to a specific example of “page information” of the disclosure. The readout time tr corresponds to a specific example of “timing information” of the disclosure. The image list generation module MIG2 corresponds to a specific example of “page information generation section” of the disclosure. The image list readout module MIR corresponds to a specific example of “restoration section” of the disclosure.

### [Operation and Function]

### (Generation of Image List IL2)

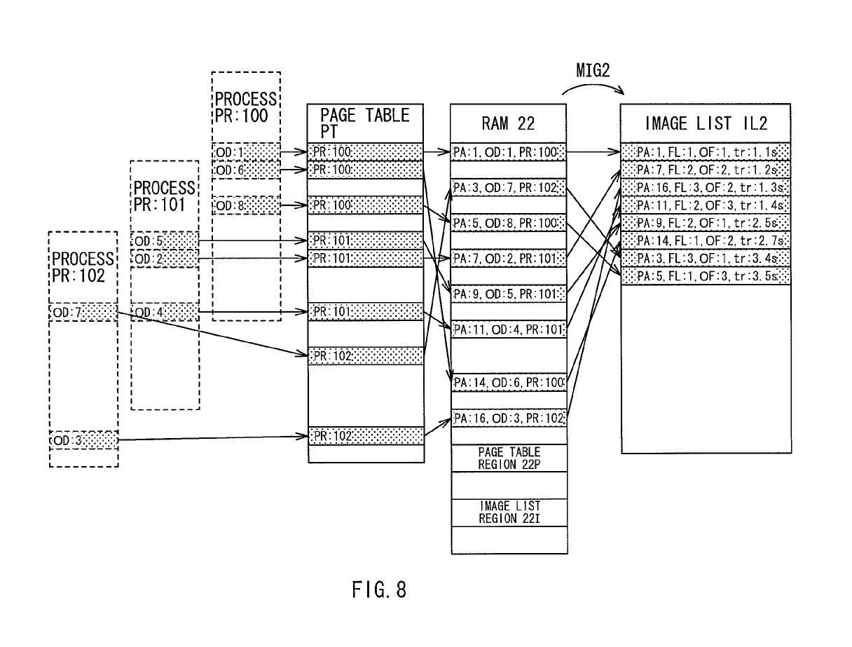

FIG. 8 schematically illustrates a memory space in the display 2, and illustrates a case where the image list IL2 is generated. To generate the image list IL2, the CPU 31 executes the image list generation module MIG2. As will be described later, the image list generation module MIG2 collects, for each page, information of memory data of the RAM 22, which is expected to be necessary after power-on, and generates the image list IL2 illustrated in FIG. 7.

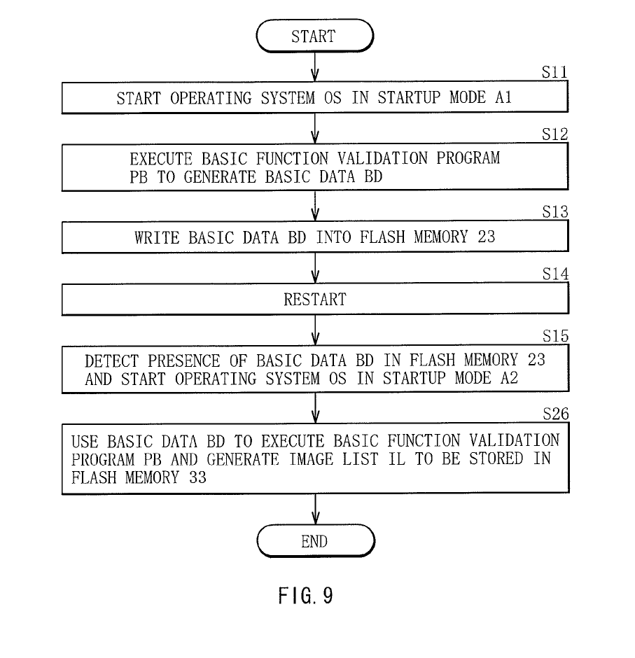

FIG. 9 illustrates a flowchart of generation of the image list IL2. The generation of the image list IL2 in the second embodiment is different from the flowchart (FIG. 4) of the generation of the snapshot image SI according to the above-described first embodiment in that the step S16 is changed to a step S26, and the step S17 is eliminated. Incidentally, the other steps are substantially the same as in the case of the above-described first embodiment (FIG. 4).

In the step S26 subsequent to the step S15, the CPU uses the basic data BD to execute the basic function validation program PB, and executes the image list generation module MIG2 to generate the image list IL2. Specifically, the CPU 31 uses the basic data BD to execute the basic function validation program PB, and accordingly validates the basic function in a time shorter than a time for performing steps S11 and S12. Then, in the step S26 (execution of the basic function validation program PB), the image list generation module MIG2 acquires a readout order OD of a page related to the memory data of the RAM 22, which is expected to be necessary after power-on, from the flash memory 33 to the RAM 22, the readout timing (readout time tr), the logical memory address LA of the page, and the process number PR of the page. The readout time tr is, namely, an occurrence timing of paging when the basic function validation program PB is executed in the step S26. After that, the image list generation module MIG2 generates the image list IL2 based on the information, and stores the image list IL2 in the flash memory 33.

(Startup of Display 2 with Use of Image List IL2)

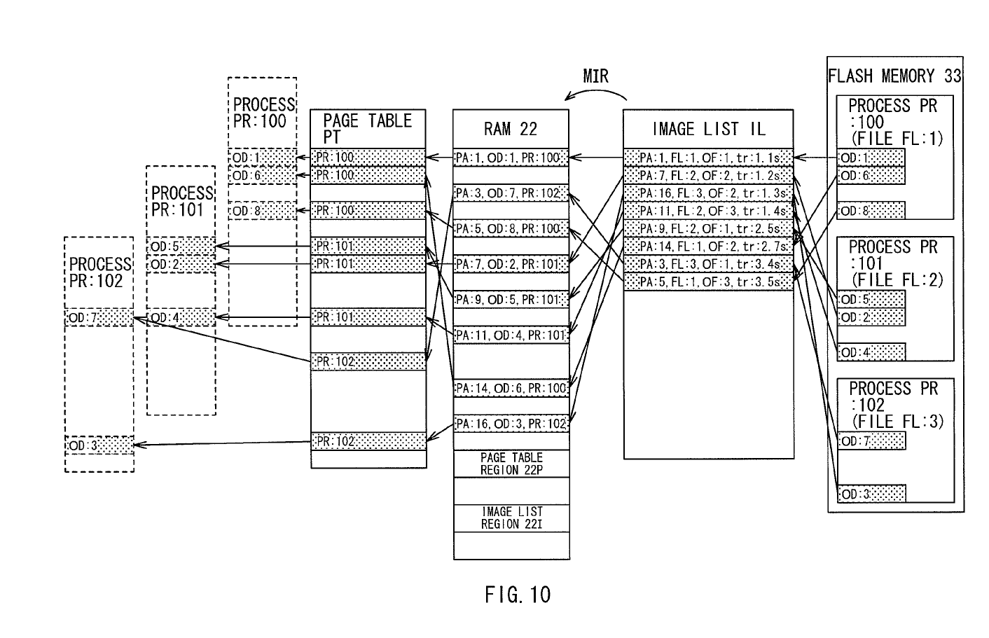

FIG. 10 schematically illustrates the memory space in the display 2, and illustrates a case where the memory data in the RAM 22 is restored based on the image list IL2 after power-on. To restore the memory data in the RAM 22, the CPU 31 executes the image list readout module MIR. The image list readout module MIR restores the memory data in the RAM 22, based on the image list IL2 and the program (file FL) stored in the flash memory 33.

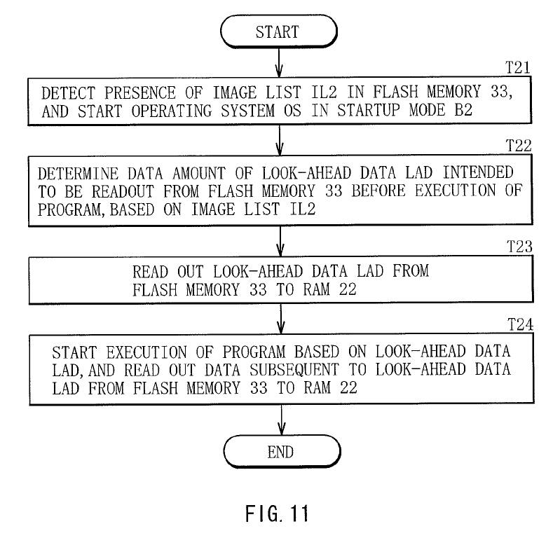

FIG. 11 illustrates a flowchart of startup of the display 2 with use of the image list IL2. In the display 2, after power-on, the CPU 31 executes the image list readout module MIR to restore the memory data in the RAM 22, and begins startup of the system concurrently with the restoration processing. The detail thereof is described below.

First, the CPU 31 executes a boot loader, detects presence of the image list IL2 in the flash memory 33, and starts the operating system OS in a startup mode B2 (step T21). In the startup mode B2, the CPU 31 reads out the data of the operating system OS from the flash memory 33 to the RAM 22, and then starts the operating system OS.

Next, the CPU 31 executes the image list readout module MIR to determine data amount of the memory data (look-ahead data LAD) which is intended to be read out from the flash memory 33 to the RAM 22 before execution of the program, based on the image list IL2 (step T22). The look-ahead data LAD is memory data which is intended to be read out before the execution of the program, in order to prevent page fault from occurring during the execution of the program in a step T24, as will be described later. The image list readout module MIR determines the data amount of the look-ahead data LAD, based on the readout time tr for each page described in the image list IL2 and a data transfer time from the flash memory 33 to the RAM 22, which is previously acquired.

Subsequently, the image list readout module MIR uses the DMA controller 35 to read out the look-ahead data LAD of the data amount determined in the step T22 from the flash memory 33 to the RAM 22 (step T23). Specifically, the image list readout module MIR firstly identifies the file FL corresponding to the process (program) stored in the flash memory 33, based on the process number PR for each page included in the image list IL2. Then, the image list readout module MIR determines a position (offset OF) of the page in the identified file FL, based on the logical memory address LA included in the image list IL2. Thereafter, the image list readout module MIR reads out the memory data from the flash memory 33 to the RAM 22, based on the information of the file FL and the offset OF.

After that, the CPU 31 starts execution of the program, based on the look-ahead data LAD restored to the RAM 22, and the image list readout module MIR uses the DMA controller 35 following the look-ahead data LAD to readout the memory data from the flash memory 33 to the RAM 22 (step T24).

The flow is completed in this way.

As described above, in the display 2, after part of the memory data in the RAM 22 is restored based on the look-ahead data LAD, the program is executed based on the look-ahead data LAD, and concurrently, the data following the look-ahead data LAD is read out to the RAM 22. In other words, in the display 2, execution of the program is started before the restoration of all memory data in the RAM 22 is completed. In the display 1 according to the above-described first embodiment, since the memory data in the RAM 22 is restored based on the snapshot image SI, execution of the program is started after restoration of all memory data in the RAM 22 is completed. On the other hand, in the display 2, execution of the program is started after only minimum memory data (look-ahead data LAD) which does not causes page fault in execution of the program is restored. Consequently, in the display 2, the startup time is allowed to be reduced.

Moreover, in the display 2, in the step T24, since the CPU 31 executes the program based on the look-ahead data LAD, possibility of suspension in execution of the program due to the page fault is allowed to be reduced and the startup time is reduced accordingly. In addition, in the step T24, the image list readout module MIR uses the DMA controller 35 to read out the memory data. Accordingly, since the data exchange between the RAM 22 and the flash memory 33 does not put a load on the CPU 31, the CPU 31 efficiently executes the program based on the look-ahead data LAD, and thus the startup time is allowed to be reduced.

### [Effect]

As described above, in the second embodiment, after part of the memory data in the RAM 22 is restored based on the look-ahead data LAD, the program is executed based on the look-ahead data LAD, and concurrently, the data following the look-ahead data LAD is read out to the RAM. Therefore, the startup time is allowed to be reduced.

In addition, in the embodiment, the image list IL2 includes the information of the readout time tr, and the data amount of the look-ahead data LAD is determined based on the image list IL2 so as to prevent page fault from occurring in subsequent execution of the program. Therefore possibility of suspension in execution of the program due to the page fault is allowed to be reduced and the startup time is reduced accordingly.

Moreover, in the embodiment, with use of the DMA controller, data exchange between the RAM 22 and the flash memory 33 is less likely to put a load on the CPU 31, and therefore the startup time is allowed to be reduced.

Furthermore, in the embodiment, since the memory data in the RAM 22 is restored based on the image list IL2 and the program (file FL) which is stored in the flash memory 33, the memory usage of the flash memory 33 is allowed to be reduced compared with the case where the snapshot image SI is used.

Other effects are similar to those in the above-described first embodiment.

### 3. Third Embodiment

A display 3 according to a third embodiment is now described. In the third embodiment, after power-on, the memory data in the RAM 22 is restored based on the snapshot image SI and the program is also executed concurrently. Note that like numerals are used to designate substantially like components of the display devices 1 and 2 according to the above-described embodiments, and the description thereof is appropriately omitted.

### [Configuration]

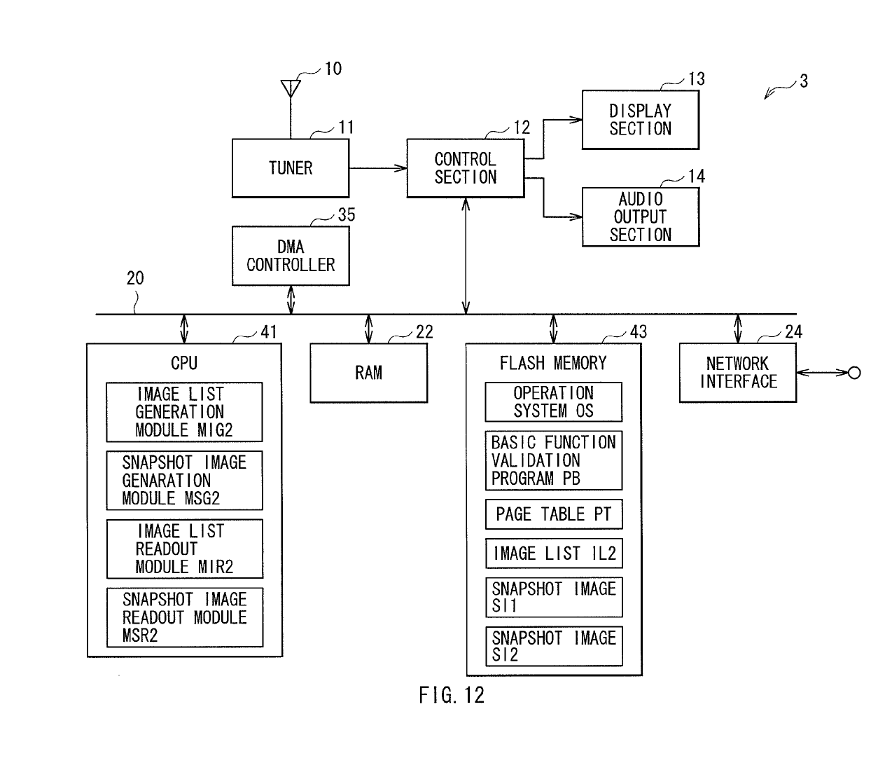

FIG. 12 illustrates a configuration example of the display 3 according to the third embodiment. The display 3 includes a flash memory 43 and a CPU 41.

The flash memory 43 holds the image list IL2 and two snapshot images SI1 and SI2. The snapshot images SI1 and SI2 hold the memory data for each page, which is expected to be necessary after power-on of the display 3, out of the memory data in the RAM 22, similarly to the snapshot image SI in the above-described first embodiment. The snapshot image SI1 relates to memory data of the operating system OS, and the snapshot image SI2 relates to memory data of programs other than the operating system OS.

The CPU 41 has a function to execute a snapshot image generation module MSG2, a snapshot image readout module MSR2, and an image list readout module MIR2. The snapshot image generation module MSG2 generates the snapshot images SI1 and SI2 based on the image list IL2 which is generated by the image list generation module MIG2, and stores the generated snapshot images SI1 and SI2 in the flash memory 43. The snapshot image readout module MSR2 restores the memory data in the RAM 22 related to the operating system OS, based on the snapshot image SI1 stored in the flash memory 43, after power-on. The image list readout module MIR2 restores the memory data in the RAM 22 related to the programs other than the operating system OS, based on the image list IL2 and the snapshot image SI2 which are stored in the flash memory 43, after power-on.

Note that, although not illustrated, the snapshot image generation module MSG2, the snapshot image readout module MSR2, and the image list readout module MIR2 are stored in the flash memory 43, and are read out from the flash memory 43 to the RAM 22, when the CPU 41 executes these modules.

The snapshot image generation module MSG2 corresponds to a specific example of “memory control section” of the disclosure. The snapshot image SI1 corresponds to a specific example of “basic page data set” of the disclosure. The snapshot image SI2 corresponds to a specific example of “application page data set” of the disclosure. The image list readout module MIR2 and the snapshot image readout module MSR2 correspond to specific examples of “restoration section” of the disclosure.

### [Operation and Function]

### (Generation of Image List IL2 and Snapshot Images SI1 and SI2)

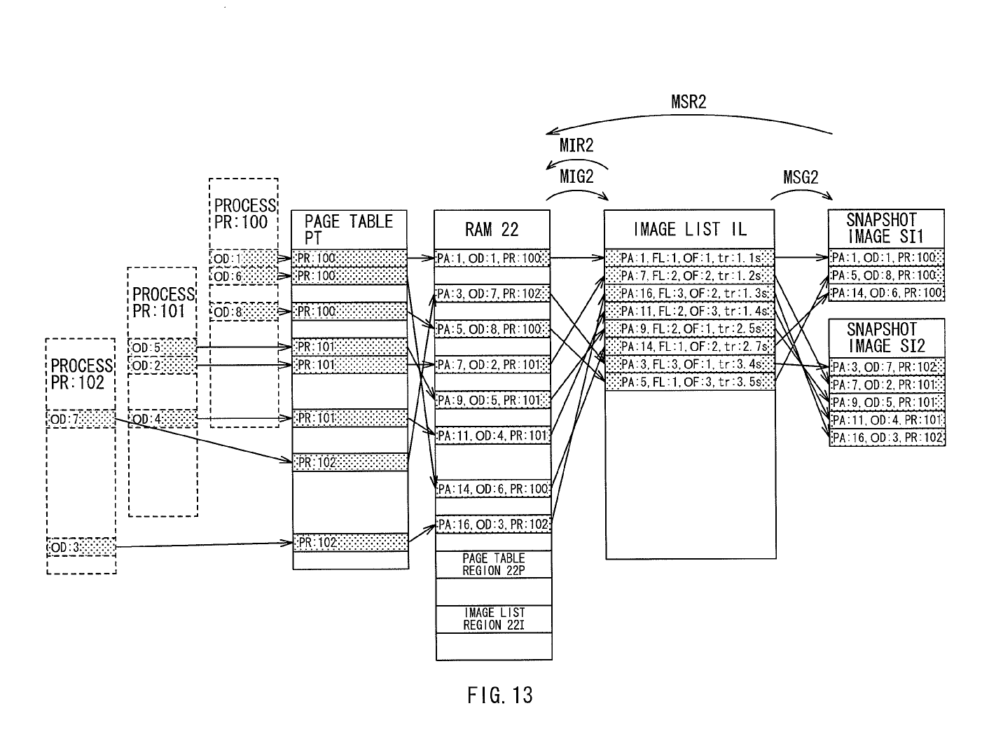

FIG. 13 schematically illustrates a memory space in the display 3. To generate the image list IL2, the CPU 41 executes the image list generation module MIG2, similarly to the case of the above-described second embodiment. To generate the snapshot images SI1 and SI2, the CPU 41 executes the snapshot image generation module MSG2. The snapshot image generation module MSG2 collects corresponding pieces of memory data from the RAM 22, based on the image list IL2 which is generated by the image list generation module MIG2, and generates the two snapshot images SI1 and SI2.

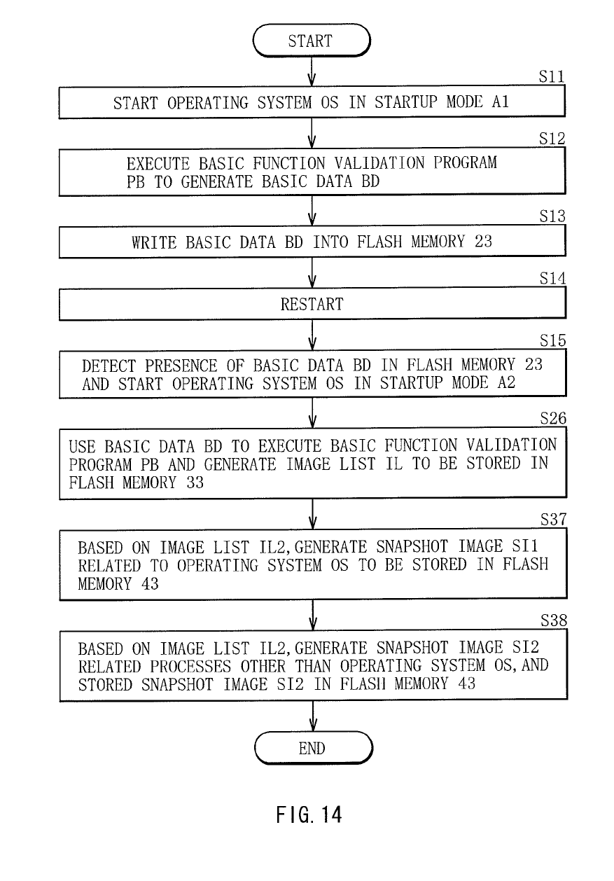

FIG. 14 illustrates a flowchart of generation of the image list IL2 and the snapshot images SI1 and SI2. The generation of the image list IL2 and the snapshot images SI1 and SI2 in the third embodiment is different from the flowchart (FIG. 4) of the generation of the snapshot image SI in the above-described first embodiment in that the step S16 is changed to a step (step S26 in the above-described second embodiment) generating the image list IL2, and the step S17 is changed to steps S37 and S38. Note that the other steps are substantially the same as in the case of the above-described first embodiment (FIG. 4).

In a step S37 subsequent to the step S26, the CPU executes the snapshot image generation module MSG2 to generate the snapshot image SI1 based on the image list IL2, and stores the snapshot image SI1 in the flash memory 43. Specifically, the snapshot image generation module MSG2 generates the snapshot image SI1, similarly to the snapshot image generation module MSG according to the above-described first embodiment. At this time, the snapshot image generation module MSG2 acquires the memory data of the page in which the process number PR described in the image list IL2 relates to the operating system OS, and generates the snapshot image SI1 based on information of the memory data and a physical memory address PA of each page.

Next, the CPU 41 executes, similarly to the step S37, the snapshot image generation module MSG2 to generate the snapshot image SI2, and stores the snapshot image SI2 in the flash memory 43 (step S38). At this time, the snapshot image generation module MSG2 acquires the memory data of the page in which the process number PR described in the image list IL2 relates to processes other than the operating system OS, and generates the snapshot image SI2 based on the memory data and information of the physical memory address PA of each page.

(Startup of Display 3 with Use of Image List IL2 and Snapshot Images SI1 and SI2)

To restore the memory data in the RAM 22, the CPU executes the snapshot image readout module MSR2 and the image list readout module MIR2, as illustrated in FIG. 13. The snapshot image readout module MSR2 restores the memory data in the RAM 22, which relates to the operating system OS, based on the snapshot image SI1 stored in the flash memory 43. In addition, the image list readout module MIR2 restores the memory data in the RAM 22, which relates to processes other than the operating system OS, based on the image list IL2 and the snapshot image SI2 which are stored in the flash memory 43.

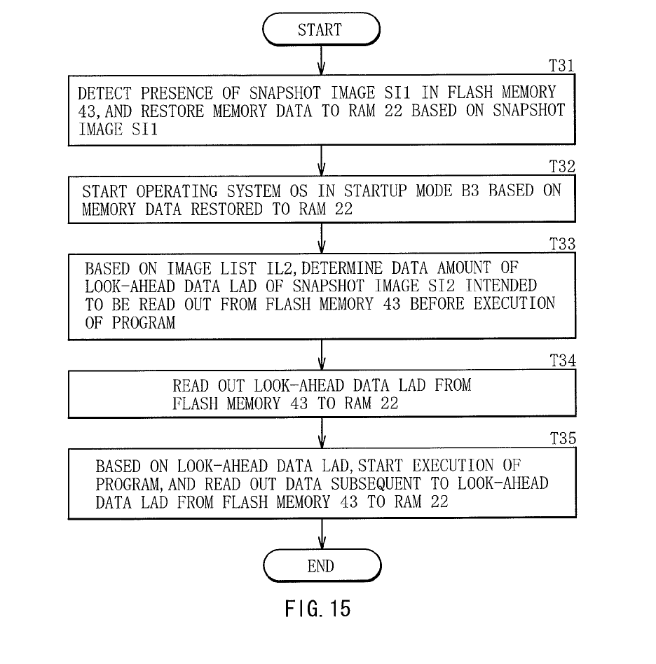

FIG. 15 illustrates a flowchart of startup of the display 3 with use of the image list IL2 and the snapshot images SI1 and SI2. In the display 3, after power-on, the CPU 41 executes the snapshot image readout module MSR2, restores the memory data in the RAM 22, which relates to the operating system OS, and begins startup of the system based on the restored memory data. Then, the display 3 restores the memory data in the RAM 22, which relates to processes other than the operating system OS, based on the snapshot image SI2 and the image list IL2, and also performs startup of the system concurrently with the restoration processing.

First, the CPU 41 executes a boot loader to detect presence of the snapshot image SI1 in the flash memory 43, and executes the snapshot image readout module MSR2. Then, the CPU 41 restores the memory data in the RAM 22, which relates to the operating system OS, based on the snapshot image SI1 (step T31).

Subsequently, the CPU 41 starts the operating system OS in a startup mode B3, based on the memory data related to the operating system OS which is restored to the RAM 22 (step T32). Specifically, the CPU 41 jumps to a start memory address in the RAM 22 in which the memory data is restored, and starts the operating system OS from the address.

Then, the CPU 41 executes the image list readout module MIR2, and determines data amount of memory data (look-ahead data LAD) which is intended to be read out from the flash memory 43 to the RAM 22 before execution of the program, out of the memory data related to the snapshot image SI2, based on the image list IL2 (step T33).

After that, the image list readout module MIR2 uses the DMA controller 35 to read out the look-ahead data LAD of the data amount which is determined in the step T33, from the flash memory 43 to the RAM 22 (step T34). Specifically, the image list readout module MIR2 uses a page table PT to convert the logical memory address LA included in the image list IL2 into a physical memory address PA, and reads out the memory data corresponding to the converted physical memory address PA from the snapshot image SI2 to the RAM 22.

Subsequently, the CPU 41 starts execution of the program based on the look-ahead data LAD restored to the RAM 22, and the image list readout module MIR2 uses the DMA controller 35 following the look-ahead data LAD to read out the memory data from the flash memory 43 to the RAM 22 (step T35).

The flow is completed in this way.

As described above, in the display 3, the memory data in the RAM 22, which relates to the operating system OS, is restored based on the snapshot image SI1, and then the operating system OS is started based on the restored memory data. After that, concurrently with the execution of the program, the memory data in the RAM 22, which relates to processes other than the operating system OS, is restored based on the snapshot image SI2. In other words, in the display 1 according to the above-described first embodiment, since the memory data in the RAM 22 is restored based on one snapshot image SI, execution of the program is started after restoration of all memory data in the RAM 22 is completed. In contrast, in the display 3, the execution of the program is started after only memory data in the RAM 22, which relates to the operating system OS, is restored. Accordingly, in the display 3, the startup time is allowed to be reduced.

Moreover, in the display 3, for example, even in the case where the flash memory 43 includes a compressed file system, execution of the program and restoration of the memory data in the RAM22 are allowed to be concurrently performed. In other words, for example, even in the case where a block size of the compressed file system of the flash memory 43 is larger than a page size of the RAM 22 (for example, in the case where the block size is 32 k bytes and the page size is 4 k bytes), the image list generation module MIG2 and the snapshot image generation module MSG2 in the display 3 collect the memory data for each page to generate the snapshot images SI1 and SI2. Therefore, the data amount of the snapshot images SI1 and SI2 is minimum necessary. Consequently, the readout amount of the data when the memory data in the RAM 22 is restored after power-on is allowed to be reduced, and thus the startup time is allowed to be reduced.

Note that, in the display 2 according to the above-described second embodiment, for example, in the case where the flash memory 33 includes a compressed file system, the startup time may be increased. In other words, for example, in the case where the block size of the compressed file system of the flash memory 33 is larger than the page size of the RAM 22, the image list readout module MIR needs to read out a compressed program (file FL), which is stored in the flash memory 33, for each block (for example, by 32 k bytes) to the RAM 22, decompress the compressed program, and then acquire a desired page (for example, 4 k bytes). In other words, in the display 2, since the readout amount of the data when the memory data in the RAM 22 is restored after power-on is large, the startup time may be increased.

On the other hand, in the display 3 according to the third embodiment, as described above, the snapshot images SI1 and SI2 are configured by data amount which is minimum necessary, so that the startup time is allowed to be reduced.

### [Effect]

As described above, in the embodiment, a plurality of snapshot images are generated, and snapshot images related to the operating system OS are separated from the other snapshot images. Accordingly, execution of the operating system is allowed to be performed concurrently with restoration of the memory data in the RAM so that the startup time is allowed to be reduced.

Moreover, in the embodiment, the snapshot image is used. Accordingly, even in the case where the flash memory 43 includes a compressed file system, the startup time is allowed to be reduced.

Other effects are similar to those in the case of the first and second embodiments.

Hereinbefore, although the technology has been described with referring to some embodiments, the technology is not limited thereto, and various modifications may be made.

For example, the technology is applied to a display in the above described embodiments. However, the application of the technology is not limited thereto, and the technology may be applied to any electronic units.

Note that the technology may be configured as described below.

(1) An information processing unit including:
a volatile memory temporarily holding, as memory data, information which indicates a plurality of programs;
a nonvolatile memory; and
a page information generation section generating page information which identifies memory data for a plurality of predetermined pages from memory data stored in the volatile memory, wherein
the page information includes a memory address for each page in the volatile memory, and a program number of a program including memory data for each page.

(2) The information processing unit according to (1), further including a memory control section generating one or more page data sets each including the memory data for the predetermined pages, based on the page information, and storing the page data sets in the nonvolatile memory.

(3) The information processing unit according to (2), wherein
the programs include basic software, and
the memory control section generates a plurality of page data sets including a basic page data set corresponding to the basic software and an application page data set corresponding to programs other than the basic software.

(4) The information processing unit according to (1), wherein the page information generation section stores the page information in the nonvolatile memory.

(5) The information processing unit according to any one of (1) to (4), wherein
the programs are stored in the nonvolatile memory, and
the page information generation section acquires the memory address and the program number when the programs stored in the nonvolatile memory are executed.

(6) The information processing unit according to (5), wherein
the page information includes timing information for each page, and
the page information generation section acquires the timing information indicating a timing at which memory data for each page is read out to the volatile memory when the programs stored in the nonvolatile memory are executed.

(7) The information processing unit according to any one of (1) to (6), wherein the memory address is a logical memory address.

(8) The information processing unit according to any one of (1) to (7), wherein the page information generation section generates the page information after the programs are updated.

(9) An information processing unit including:
a volatile memory;
a nonvolatile memory holding page restoration information; and
a restoration section restoring memory data for a plurality of predetermined pages to the volatile memory, based on the page restoration information.

(10) The information processing unit according to (9), wherein
the page restoration information includes one or more page data sets including the memory data for the predetermined pages, and
the restoration section restores memory data based on the page data sets.

(11) The information processing unit according to (10), wherein
the programs include basic software, and
the page restoration information includes a plurality of page data sets including a basic page data set corresponding to the basic software, and an application page data set corresponding to programs other than the basic software.

(12) The information processing unit according to (11), wherein
the programs are stored in the nonvolatile memory,
the page restoration information further includes page information that identifies the memory data for the predetermined pages, the page information including a memory address for each page in the volatile memory, a program number of a program including memory data of each page, and timing information related to each page, the timing information indicating a timing at which memory data for each page is read out to the volatile memory when the programs stored in the nonvolatile memory are executed, and
the restoration section restores memory data corresponding to the basic software based on the basic page data set, determines, based on the timing information, an amount of look-ahead data of memory data which is intended to be restored previously based on the application page data set, starts restoration of memory data corresponding to the application software based on the application page data set, and starts execution of the programs based on the restored memory data after a data amount of a restored memory data reaches the amount of the look-ahead data.

(13) The information processing unit according to (9), wherein
the page restoration information includes page information that identifies the memory data for the predetermined pages,
the page information includes a memory address for each page in the volatile memory and a program number of a program including memory data for each page, and
the restoration section restores memory data based on the page information.

(14) The information processing unit according to (13), wherein
the programs are stored in the nonvolatile memory, and
the restoration section restores memory data, based on data of the programs stored in the nonvolatile memory and the page information.

(15) The information processing unit according to (14), wherein
the page information includes timing information related to each page, the timing information indicating a timing at which memory data for each page is read out to the volatile memory when the programs stored in the nonvolatile memory is executed, and
the restoration section determines an amount of look-ahead data of memory data which is intended to be restored previously based on the timing information, starts restoration of the memory data, and starts execution of the programs based on the restored memory data, after a data amount of a restored memory data reaches the amount of the look-ahead data.

(16) An information processing method including:
executing a plurality of programs based on memory data in a volatile memory; and
generating page information which includes a memory address for each of a plurality of predetermined pages in the volatile memory and a program number of a program including memory data for each of the predetermined pages, the page information identifying memory data of the predetermined pages in the memory data stored in the volatile memory.

(17) An information processing method of restoring memory data for a plurality of predetermined pages to a volatile memory, based on page restoration information stored in a nonvolatile memory.

It should be understood by those skilled in the art that various modifications, combinations, sub-combinations, and alterations may occur depending on design requirements and other factors insofar as they are within the scope of the appended claims or the equivalents thereof.

What is claimed is:

1. An information processing unit comprising:
a volatile memory temporarily holding, as memory data, information which indicates a plurality of programs;
a nonvolatile memory; and
a page information generation section generating page information which identifies memory data for a plurality of predetermined pages from memory data stored in the volatile memory, wherein
the page information includes a memory address for each page in the volatile memory, and a program number of a program including memory data for each page.

2. The information processing unit according to claim 1, further comprising a memory control section generating one or more page data sets each including the memory data for the predetermined pages, based on the page information, and storing the page data sets in the nonvolatile memory.

3. The information processing unit according to claim 2, wherein
the programs include basic software, and
the memory control section generates a plurality of page data sets including a basic page data set corresponding to the basic software and an application page data set corresponding to programs other than the basic software.

4. The information processing unit according to claim 1, wherein the page information generation section stores the page information in the nonvolatile memory.

5. The information processing unit according to claim 1, wherein
the programs are stored in the nonvolatile memory, and
the page information generation section acquires the memory address and the program number when the programs stored in the nonvolatile memory are executed.

6. The information processing unit according to claim 5, wherein
the page information includes timing information for each page, and
the page information generation section acquires the timing information indicating a timing at which memory data for each page is read out to the volatile memory when the programs stored in the nonvolatile memory are executed.

7. The information processing unit according to claim 1, wherein the memory address is a logical memory address.

8. The information processing unit according to claim 1, wherein the page information generation section generates the page information after the programs are updated.

9. An information processing unit comprising:
a volatile memory;
a nonvolatile memory holding page restoration information; and
a restoration section restoring memory data for a plurality of predetermined pages to the volatile memory, based on the page restoration information.

10. The information processing unit according to claim 9, wherein
the page restoration information includes one or more page data sets including the memory data for the predetermined pages, and
the restoration section restores memory data based on the page data sets.

11. The information processing unit according to claim 10, wherein
the programs include basic software, and
the page restoration information includes a plurality of page data sets including a basic page data set corresponding to the basic software, and an application page data set corresponding to programs other than the basic software.

12. The information processing unit according to claim 11, wherein
the programs are stored in the nonvolatile memory,
the page restoration information further includes page information that identifies the memory data for the predetermined pages, the page information including a memory address for each page in the volatile memory, a program number of a program including memory data of each page, and timing information related to each page, the timing information indicating a timing at which memory data for each page is read out to the volatile memory when the programs stored in the nonvolatile memory are executed, and
the restoration section restores memory data corresponding to the basic software based on the basic page data set, determines, based on the timing information, an amount of look-ahead data of memory data which is intended to be restored previously based on the application page data set, starts restoration of memory data corresponding to the application software based on the application page data set, and starts execution of the programs based on the restored memory data after a data amount of a restored memory data reaches the amount of the look-ahead data.

13. The information processing unit according to claim 9, wherein
the page restoration information includes page information that identifies the memory data for the predetermined pages,
the page information includes a memory address for each page in the volatile memory and a program number of a program including memory data for each page, and
the restoration section restores memory data based on the page information.

14. The information processing unit according to claim 13, wherein
the programs are stored in the nonvolatile memory, and
the restoration section restores memory data, based on data of the programs stored in the nonvolatile memory and the page information.

15. The information processing unit according to claim 14, wherein
the page information includes timing information related to each page, the timing information indicating a timing at which memory data for each page is read out to the volatile memory when the programs stored in the nonvolatile memory is executed, and
the restoration section determines an amount of look-ahead data of memory data which is intended to be restored previously based on the timing information, starts restoration of the memory data, and starts execution of the programs based on the restored memory data, after a data amount of a restored memory data reaches the amount of the look-ahead data.

16. An information processing method comprising:
executing a plurality of programs based on memory data in a volatile memory; and
generating page information which includes a memory address for each of a plurality of predetermined pages in the volatile memory and a program number of a program including memory data for each of the predetermined pages, the page information identifying memory data of the predetermined pages in the memory data stored in the volatile memory.

17. An information processing method of restoring memory data for a plurality of predetermined pages to a volatile memory, based on page restoration information stored in a nonvolatile memory.
